(19) United States
(12) Patent Application Publication
(10) Pub. No.: US 2026/0343412 A1
(43) Pub. Date: Oct. 29, 2026

(54) METHODS, DEVICES, AND MEDIUM FOR COMMUNICATION

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 19/110,193

(22) PCT Filed: Sep. 21, 2022
(86) PCT No.: PCT/CN2022/120352

§ 371 Date: Mar. 10, 2025

(51) Int. Cl. H04W 52/02; H04W 24/08

(52) U.S. Cl. CPC H04W 52/0235; H04W 24/08

(57) ABSTRACT

Example embodiments of the present disclosure relate to methods, devices, and computer storage medium for communication. A terminal device receives a configuration from a network device; determines whether a low power wake up signal is configured based on the configuration; if the low power wake up signal is configured, determines a scaling factor based on at least one of: a value indication of the scaling factor from the network device, a periodicity of low power wake up signal monitoring window, or a DRX cycle length; and determines a measurement duration based on the scaling factor. As such, the terminal device may determine a measurement duration based on a scaling factor if a LP-WUS is configured, and thus the measurement duration may be longer. Accordingly, the terminal device may perform a measurement with a longer duration rather than a short one, thus some unnecessary measurements may be avoided at the terminal device. Therefore, the power consumption may be further reduced at the terminal device.

### FIELD

Example embodiments of the present disclosure generally relate to the field of communication techniques and in particular, to methods, devices, and a computer readable medium for communication.

### BACKGROUND

Several technologies have been proposed for power saving of a terminal device. For example, a user equipment (UE) may enter to a radio resource control (RRC) idle/inactive state to reduce power consumption. However, it is still critical for power limited devices, e.g., the Internet of Things (IoT) devices, wearable devices, etc., since periodic paging monitoring and measurement consume considerable power at UE side even in RRC idle/inactive state. Therefore, it is beneficial for UE to further reduce the power consumption.

### SUMMARY

In general, example embodiments of the present disclosure provide methods, devices and a computer storage medium for communication.

In a first aspect, there is provided a method of communication. The method comprises: receiving, at a terminal device, a configuration from a network device; determining whether a low power wake up signal is configured based on the configuration; in accordance with a determination that the low power wake up signal is configured, determining a scaling factor based on at least one of: a value indication of the scaling factor from the network device, a periodicity of low power wake up signal monitoring window, or a discontinuous reception (DRX) cycle length; and determining a measurement duration based on the scaling factor.

In a second aspect, there is provided a method of communication. The method comprises: receiving, at a terminal device, a low power wake up signal from a network device at a first time; determining a time length from the first time to a second time at which the terminal device is able to start monitoring at least one paging occasion (PO) or paging early indication occasion (PEI-O), the time length being based on at least one of: a processing time of the low power wake up signal, a feedback delay of acknowledge of the low power wake up signal, an activation time of a main radio of the terminal device, a time duration to an end of a complete synchronization signal block (SSB) burst, a processing time of SSB, whether an SSB measurement is required, or whether an SSB associated with the monitoring of the at least one PO or PEI-O is known to the terminal device.

In a third aspect, there is provided a method of communication. The method comprises: transmitting, at a network device, a low power wake up signal to a terminal device at a first time; determining a time length from the first time to a second time at which the terminal device is able to start monitoring a paging occasion (PO) or a paging early indication occasion (PEI-O); and transmitting paging downlink control information (DCI) in the PO or a PEI in the PEI-O after the second time.

In a fourth aspect, there is provided a terminal device. The terminal device comprises a processor and a memory. The memory is coupled to the processor and stores instructions thereon. The instructions, when executed by the processor, cause the terminal device to perform the method according to the first or the second aspect above.

In a fifth aspect, there is provided a network device. The network device comprises a processor and a memory. The memory is coupled to the processor and stores instructions thereon. The instructions, when executed by the processor, cause the network device to perform the method according to the third aspect above.

In a sixth aspect, there is provided a computer readable medium having instructions stored thereon, the instructions, when executed on at least one processor, causing the at least one processor to carry out the method according to the first aspect or the second aspect or the third aspect above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2A illustrates a schematic diagram of resources occupied by an LP signal which can be used in some example embodiments of the present disclosure;

FIGS. 2B-2C illustrate schematic diagrams of OOK symbols which can be used in some example embodiments of the present disclosure;

FIG. 3 illustrates a signalling chart illustrating communication process in accordance with some embodiments of the present disclosure;

FIG. 4 illustrates a signalling chart illustrating communication process in accordance with some embodiments of the present disclosure;

FIG. 5 illustrates a signalling chart illustrating communication process in accordance with some embodiments of the present disclosure;

FIG. 6 illustrates a schematic diagram of a time length according to some embodiments of the present disclosure;

FIG. 7 illustrates a schematic diagram of a time length according to some embodiments of the present disclosure;

FIG. 8 illustrates a schematic diagram of a time length according to some embodiments of the present disclosure;

FIG. 9 illustrates a flowchart of an example method in accordance with some embodiments of the present disclosure;

FIG. 10 illustrates a flowchart of an example method in accordance with some embodiments of the present disclosure;

FIG. 11 illustrates a flowchart of an example method in accordance with some embodiments of the present disclosure; and

FIG. 12 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, for a UE in RRC idle/inactive state, the periodic paging monitoring and measurement consume considerable power at UE side, which is critical for the power limited devices such as IoT devices or wearable devices.

A low power wake up signal (LP-WUS) is proposed in NR Release 18, which may study and evaluate techniques of low power signals and low power receivers, to enable extreme low power consumption and low wake up latency.

In some cases, the UE may use discontinuous reception (DRX) in RRC idle or inactive state in order to reduce power consumption. The UE may monitor one paging occasion (PO) per DRX cycle. A PO can consist of multiple time slots, e.g., sub-frame or orthogonal frequency divided multiple (OFDM) symbol. A PO may refer to a set of physical downlink control channel (PDCCH) monitoring occasions, such as a set of SxX consecutive PDCCH monitoring occasions, where S is the number of actual transmitted synchronization signal blocks (SSB) determined according to ssb-PositionsInBurst in system information block 1 (SIB1), and X is the nrofPDCCH-MonitoringOccasionPerSSB-InPO if configured or is equal to 1 otherwise. The [x×S+K]th PDCCH monitoring occasion for paging in the PO may correspond to the Kth transmitted SSB, where x=0, 1, . . . , X−1, and K=1, 2, . . . , S. Paging downlink control information (DCI) can be sent in the PO. One paging frame (PF) may refer to one radio frame and may contain one or multiple PO(s) or starting point of a PO.

It is up to UE implementation which SSB is selected for the determination of the PDCCH monitoring occasion in a PO. Practically, the UE may determine the SSB based on measurement result of an SSB burst, UE may choose an SSB with best quality.

In some cases, the UE may use paging early indication (PEI) in RRC idle or inactive state in order to reduce power consumption. The UE may monitor one PEI occasion per DRX cycle. A PEI occasion (PEI-O) is a set of PDCCH monitoring occasions and can consist of multiple time slots (e.g. subframes or OFDM symbols) where PEI can be sent. In multi-beam operations, the UE assumes that the same PEI is repeated in all transmitted beams and thus the selection of the beam(s) for the reception of the PEI is up to UE implementation.

A PEI occasion is a set of S*X consecutive PDCCH monitoring occasions, where S is the number of actual transmitted SSBs determined according to ssb-PositionsInBurst in SIB1, and X is the nrofPDCCH-MonitoringOccasionPerSSB-InPO if configured or is equal to 1 otherwise. The [x*S+K]th PDCCH monitoring occasion for PEI in the PEI occasion corresponds to the Kth transmitted SSB, where x=0, 1, . . . , X−1, and K=1, 2, . . . , S. The PDCCH monitoring occasions for PEI which do not overlap with UL symbols (determined according to tdd-UL-DL-ConfigurationCommon) are sequentially numbered from zero starting from the first PDCCH monitoring occasion for PEI in the PEI-O. When the UE detects a PEI within its PEI-O, the UE is not required to monitor the subsequent monitoring occasion(s) associated with the same PEI-O.

As described in 3GPP TS 38.213, if the UE detects PEI and the PEI indicates the subgroup the UE belongs to monitor its associated PO, the UE monitors the associated PO. If the UE does not detect PEI on the monitored PEI occasion or the PEI does not indicate the subgroup the UE belongs to monitor its associated PO, the UE is not required to monitor the associated PO.

Similarly, it is up to UE implementation which SSB is selected for the determination of the PDCCH monitoring occasion in a PEI-O.

It is understood that one benefit of LP-WUS is the potential low paging latency, the UE may monitor LP-WUS continually or frequently without consuming too much power, therefore it may be woke up shortly after the network device (such as a gNB) making the decision to page the UE. However, to achieve the low paging latency, overprovision of POs and the associated LP-WUS signal may be needed. The term “overprovision” means the POs are provided with a very short periodicity UE may not actually need.

Embodiments of the present disclosure provide a solution of communication. In the solution, a measurement duration may be determined based on a scaling factor if a LP-WUS is configured, and thus the measurement duration may be longer and unnecessary measurement may be avoided. As such, the power consumption may be further reduced at the terminal device. Principles and implementations of the present disclosure will be described in detail below with reference to the figures.

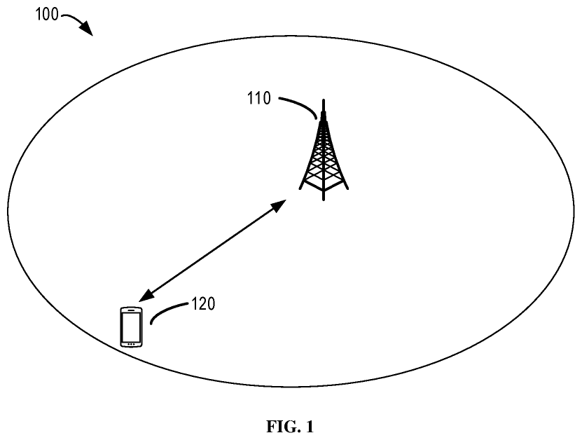

FIG. 1 illustrates an example communication system 100 in which some embodiments of the present disclosure can be implemented. The communication network 100 includes a network device 110 and a terminal device 120. The network device 110 can provide services to the terminal device 120.

In the system 100, it is assumed that the terminal device 120 is located within coverage of the network device 110. In some examples, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). In some embodiments, the network device 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

In some embodiments, the terminal device 120 may be in a main mode. In the context of the present disclose, the terms “main radio”, “main receiver” can be used interchangeably. The terminal device 120 may receive/transmit normal DL/UL transmission (e.g., PDSCH, PDCCH, PUSCH, PUCCH, etc.) in the main mode with the main radio.

In some embodiments, the terminal device 120 may be in an idle/inactive mode. For example, the same coverage as the normal DL/UL transmission cannot be provided and the terminal device 120 may receive wake up signals (WUS) with wake up receivers (WUR).

In some embodiments, the primary target for the WUS or WUR may be power-sensitive, small form-factor devices including IoT use cases (such as industrial sensors, controllers) and wearables. In some examples, low power wake up receiver architectures may be studied and evaluated. In some examples, wake up signal designs to support wake up receivers may be studied and evaluated. In some examples, L1 procedures and higher layer protocol changes needed to support the wake up signals may be studied and evaluated. In some examples, it is proposed to study potential UE power saving gains compared to the existing power saving mechanisms and their coverage availability, as well as latency impact. For example, system impact, such as network power consumption, coexistence with non-low-power-WUR UEs, network coverage/capacity/resource overhead may be included.

In some embodiments, the terminal device 120 may be in a low power mode. In the context of the present disclose, the terms “low power mode”, “LP mode”, “ultra-low power mode” can be used interchangeably, and the terms “low power radio”, “ultra-low power radio”, “low power receiver”, “ultra-low power receiver”, “wake-up receiver” can be used interchangeably.

In the present disclosure, the term “low power (LP) mode” may refer to a mode that the terminal device 120 is not required to perform at least one of: paging monitoring, cell selection and re-selection, measurement based on a synchronization signal block (SSB) or channel state information—reference signal (CSI-RS), PDCCH monitoring, UL transmission, etc., and the terminal device 120 is required to perform LP signal monitoring and/or detection.

In the present disclosure, the term “low power (LP) radio” may refer to a radio used in the low power mode for transmission/reception. In an embodiment, the LP radio may be independent to the main radio, and it is not used for transmission/reception of the normal DL/UL transmissions. In another embodiment, the LP radio may share at least a part of the components of the main radio, and it may have lower power consumption than the main radio.

In some embodiments, the terminal device 120 may perform, when in a main mode, at least one of: paging monitoring, cell selection and re-selection, measurement based on SSB or CSI-RS, PDCCH monitoring, or UL transmission.

In some embodiments, the terminal device 120 may enter the LP mode by switching off the main radio. For example, the terminal device 120 is allowed to switch off its main radio and switch on its LP radio, wherein the LP radio is used to receive the LP signals and the main radio is used to receive or transmit the signals other than the LP signals.

Communications in the system 100, between the network device 110 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network device 110 and the terminal device 120) and their connection relationships and types shown in FIG. 1 are only for the purpose of illustration without suggesting any limitation. The system 100 may include any suitable numbers of devices adapted for implementing embodiments of the present disclosure.

In some example embodiments, the terminal device 120, when in a low power mode, may receive a low power signal, such as an LP-WUS. In some embodiments, the LP-WUS may be used for indicating the terminal device 120 to wake up from the LP mode, and start to monitor a paging occasion for paging DCI.

In some embodiments, the LP-WUS may be based on at least one amplitude modulation sequence, where the sequence may include a symbol with higher amplitude and a symbol with lower amplitude. In some examples, the amplitude modulation may include amplitude shift keying (ASK) or on-off keying (OOK) modulation. Specifically, on-off keying (OOK) modulation is widely considered due to its very simple receiver architecture and ultra-low power consumption. With OOK modulation, the receiver may detect the envelop or energy of the time domain signal with a relatively low sampling rate, and without complicated baseband processing. As an example, the OOK modulation is considered in the following disclosure as one of the amplitude modulation. An OOK modulation sequence may include at least one OOK on-symbol and at least one OOK off-symbol. The present disclosure does not limit this aspect. In some other embodiments, the LP-WUS may be based on at least one Gold sequence.

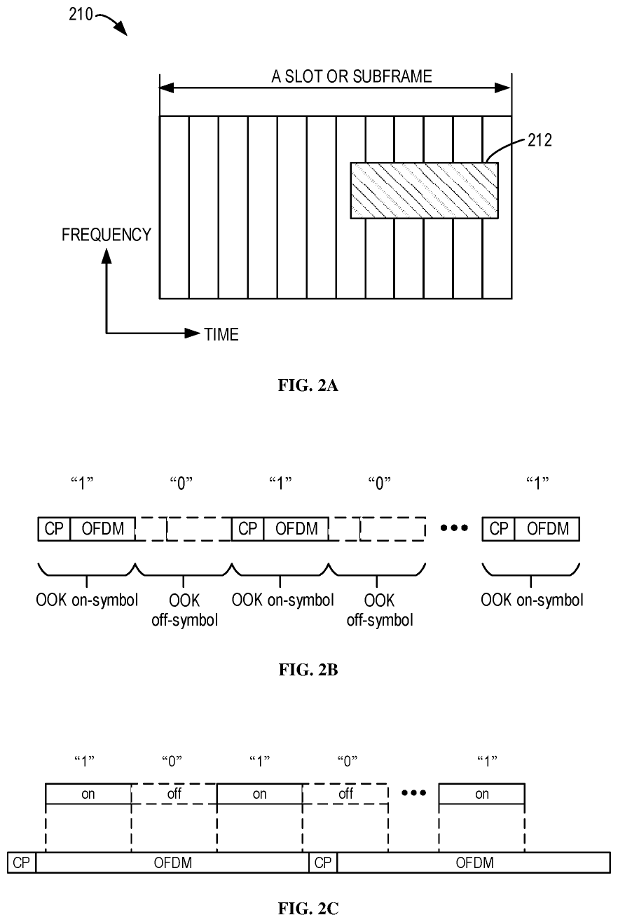

In some embodiments, the LP-WUS may occupy a set of time/frequency resources for a serving cell. FIG. 2A illustrates a schematic diagram of resources 210 occupied by an LP-WUS which can be used in some example embodiments of the present disclosure. In frequency domain, the resources allocated to the LP-WUS 212 may be overlapped with a set of PRBs or subcarriers, i.e., the terminal device 120 may be indicated a set of PRBs or subcarriers, and the frequency resources of the set of PRBs or subcarriers are used by the LP-WUS 212. In time domain, the resources allocated to the LP-WUS 212 may be overlapped with a set of OFDM symbols, i.e., the terminal device 120 may be indicated a set of OFDM symbols, and the time resources of the set of OFDM symbols are used by the LP-WUS 212.

In some examples, OOK modulation is used to generate the LP-WUS, an OOK symbol can be an OOK on-symbol (denoted by logical “1”) or an OOK off-symbol (denoted by logical “0”), where the OOK on-symbol has a relatively high power, and the OOK off-symbol has zero power or relatively low power.

It is to be understood that the OOK symbol may be equal to or may be not equal to an OFDM symbol. FIGS. 2B-2C illustrate schematic diagrams of OOK symbols which can be used in some example embodiments of the present disclosure.

As shown in FIG. 2B, an OOK on-symbol or an OOK off-symbol may have a duration which equals to the duration of an OFDM symbol. In this case, an OOK on-symbol and an OOK off-symbol are realized by a non-zero power OFDM symbol and a zero power OFDM symbol respectively.

As shown in FIG. 2C, an OOK on-symbol or an OOK off-symbol may have a duration which is shorter than an OFDM symbol. In this case, the OOK on-symbol and OOK off-symbol can be realized by DFT-s-OFDM, or by independent time domain generation.

In some embodiments, an LP-WUS may include a sequence of OOK symbols which is formed by at least one OOK on-symbol and at least one OOK off-symbol, e.g., “1010 . . . 1” as shown in FIGS. 2B-2C.

Please note that, in the present disclosure, if not specified otherwise, the term “OFDM symbol” indicates CP-OFDM symbol, or any variant of OFDM symbol, e.g., GI-OFDM, zero CP OFDM, unique word OFDM, etc.

In some embodiments, the OOK on-symbol has a higher power, and the OOK off-symbol has a lower power. In the context of the present disclose, the terms “power”, “energy”, “amplitude”, “strength” may be used interchangeably.

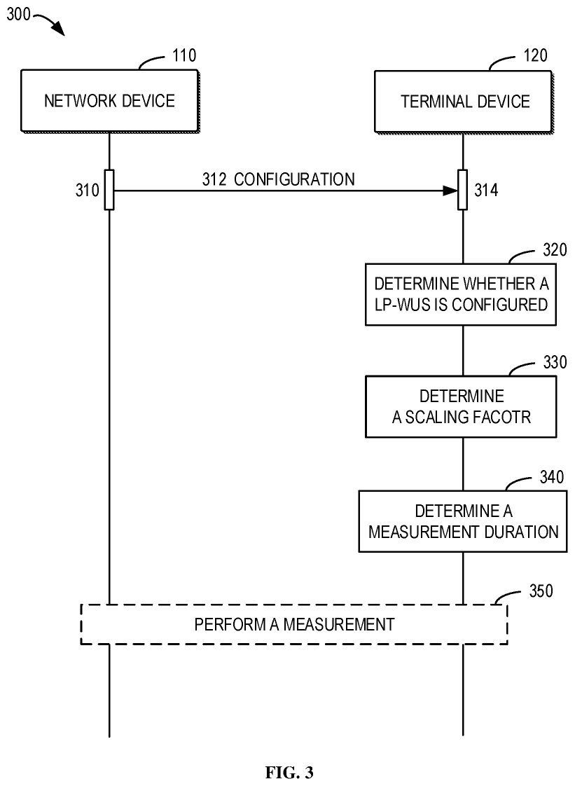

Reference is further made to FIG. 3, which illustrates a signalling chart illustrating communication process 300 in accordance with some example embodiments of the present disclosure. Only for the purpose of discussion, the process 300 will be described with reference to FIG. 1. The process 300 may involve the network device 110 and the terminal device 120.

The network device 110 transmits 310 a configuration 312 to the terminal device 120. In some example embodiments, the configuration 312 may indicate whether a low power wake up signal is configured. In some example embodiments, the configuration 312 may be transmitted via an RRC message/signalling. In some examples, the configuration 312 may be a paging configuration. In some other examples, the configuration 312 may be a cell re-selection configuration. It is understood that the configuration 312 may be any of other configurations which are not listed in the present disclosure.

On the other side of communication, the terminal device 120 receive 314 the configuration 312. In some example embodiments, the terminal device 120 may receive a paging configuration or a cell re-selection configuration. The terminal device 120 determines 320 whether a low power wake up signal is configured based on the configuration 312.

Additionally or alternatively, the terminal device 120 may determine whether a periodicity of paging occasions is greater than a density threshold. In some embodiments, a paging occasion with a density greater than (or not less than) the density threshold may refer to a dense PO. For example, a paging occasion may be configured with a high time domain density (e.g., greater than a density threshold) in order to reduce the paging latency. In some examples, the density threshold may be 320 ms or another density, the present disclosure does not limit this aspect.

Additionally or alternatively, the terminal device 120 may determine whether a DRX cycle length is smaller than a length threshold. In some embodiments, a DRX cycle length smaller than (or not larger than) a length threshold may refer to a small DRX cycle length. In some examples, the length threshold may be 1.28 second, 0.64 second or another length, the present disclosure does not limit this aspect.

If the terminal device 120 determines that a low power wake up signal is configured, the terminal device 120 determines 330 a scaling factor based on one or more of: a value indication of the scaling factor from the network device 110, a periodicity of low power wake up signal monitoring window, or a DRX cycle length.

In some example embodiments, the terminal device 120 may determine the scaling factor if one or more of the following conditions are met: (1) a low power wake up signal is configured; (2) a periodicity of paging occasions is greater than a density threshold; or (3) a DRX cycle length is smaller than a length threshold. In some examples, the terminal device 120 may determine that the scaling factor is applied and the scaling factor is greater than 1 if at least one of the conditions (1)-(3) is met.

For example, if the low power wake up signal is configured and the DRX cycle length is smaller than a length threshold, the terminal device 120 may determine the scaling factor.

In some other example embodiments, the terminal device 120 may determine that the scaling factor is not applied if none of the conditions (1)-(3) is met or if at least one of the conditions (1)-(3) is not met. In some other example embodiments, the terminal device 120 may determine that the scaling factor equals to 1 if none of the conditions (1)-(3) is met or if at least one of the conditions (1)-(3) is not met.

For example, if the low power wake up signal is not configured, the terminal device 120 may determine that the scaling factor is not applied or the scaling factor equals 1. For another example, if the low power wake up signal is configured but the DRX cycle length is greater than a length threshold, the terminal device 120 may determine that the scaling factor is not applied or the scaling factor equals 1.

In the present disclosure, the scaling factor is applied may refer to a measurement duration is determined based on the scaling factor, and the scaling factor is not applied may refer to a measurement duration is determined independent of the scaling factor.

In some embodiments, the scaling factor may be determined based on a value indication of the scaling factor from the network device 110. For example, the network device 110 may generate a value indication and transmit the value indication to the terminal device 120. In some examples, the value indication may be transmitted via an RRC message, for example, the value indication may be carried in specific information element of RRC. In some examples, the value indication may indicate the scaling factor, and the terminal device 120 may determine the value of the scaling factor based on the value indication.

In some embodiments, the scaling factor may be determined based on a periodicity of low power wake up signal monitoring window, which also refers to a periodicity of low power wake up signal monitoring occasion. In some embodiments, the scaling factor may be determined based on a DRX cycle length.

As a specific example, if the periodicity of low power wake up signal monitoring window or the DRX cycle length is 160 ms, the terminal device 120 may determine that the scaling factor is 2. As another specific example, if the periodicity of low power wake up signal monitoring window or the DRX cycle length is 80 ms, the terminal device 120 may determine that the scaling factor is 4. It is understood that the specific examples are only for the purpose of illustration, without suggesting any limitation as to the scope of the disclosure. Other examples are also applied and the present disclosure does not limit this aspect.

The terminal device 120 determines 340 a measurement duration. In some example embodiments, the terminal device 120 may determine the measurement duration based on the scaling factor.

In some example embodiments, the measurement duration is determined based on another duration and the scaling factor, another duration may be a legacy measurement duration (or may be called as a first duration in the present disclosure). For example, if the scaling factor is represented as a and the first duration is represented as T0, then the measurement duration may be a×T0. In some examples, the first duration (T0) may be determined based on one or more of: the DRX cycle length, an SSB-based radio resource management (RRM) measurement timing configuration (SMTC) periodicity, or a frequency range.

In addition or alternatively, the terminal device 120 may perform 350 a measurement based on the measurement duration.

In some example embodiments, the measurement duration may be called as an RRM measurement duration, which may be any of: a synchronization signal-reference signal received power (SS-RSRP) measurement duration, a synchronization signal-reference signal received quality (SS-RSRQ) measurement duration, a detection duration, or an evaluation duration.

In some examples, the RRM measurement duration may be an SS-RSRP measurement duration or an SS-RSRQ measurement duration, and the terminal device 120 shall perform SS-RSRP or SS-RSRQ measurement at least once in the RRM measurement duration. For example, the measurement may be applied for serving cell measurement, intra-frequency cell measurement, or inter-frequency cell measurement.

In some examples, the RRM measurement duration may be a detection duration, and the terminal device 120 shall be able to evaluate whether a newly detectable cell meets the reselection criteria within the detection duration. For example, the measurement may be applied for intra-frequency cell detection or inter-frequency cell detection.

In some examples, the RRM measurement duration may be an evaluation duration, and the terminal device 120 may perform filtering of the SS-RSRP or SS-RSRQ measurement results and the terminal device 120 shall be capable of evaluating that the cell has met reselection criterion within the evaluation duration after the filtering. For example, the evaluation may be applied for intra-frequency cell evaluation or inter-frequency cell evaluation.

The above various embodiments of the present disclosure may have partial impact to the current specification. For serving cell measurement and evaluation, the RRM measurement duration is an SS-RSRP or SS-RSRQ measurement duration or an evaluation duration, UE is required to perform SS-RSRP or SS-RSRQ measurement or evaluation at least once in the RRM measurement duration. For example, the current specification may be updated as follows in view of the above various embodiments of the present disclosure.
The UE shall measure the SS-RSRP and SS-RSRQ level of the serving cell and evaluate the cell selection criterion S defined in TS 38.304 for the serving cell at least once every a*M1*N1 DRX cycle; where:
   M1=2 if SMTC periodicity (TSMTC)>20 ms and DRX cycle≤0.64 second, otherwise M1=1.
   a=1 if LP-WUS is not configured,
   otherwise a equals value of scallingFactorLPWUS, where scallingFactorLPWUS is determined based on an RRC information element.
The UE shall filter the SS-RSRP and SS-RSRQ measurements of the serving cell using at least 2 measurements. Within the set of measurements used for the filtering, at least two measurements shall be spaced by, at least DRX cycle/2.
If the UE has evaluated according to Table 4.2.2.2-1 in Nₛₑᵣᵥ consecutive DRX cycles that the serving cell does not fulfil the cell selection criterion S, the UE shall initiate the measurements of all neighbour cells indicated by the serving cell, regardless of the measurement rules currently limiting UE measurement activities.

TABLE 4.2.2.2-1
Nₛₑᵣᵥ

| DRX cycle | Scaling Factor (N1) | | Nₛₑᵣᵥ [number |
|---|---|---|---|
| length [s] | FR1 | FR2^{Note1} | of DRX cycles] |
| 0.32 | 1 | 8 | a*M1*N1*4 |
| 0.64 | | 5 | a*M1*N1*4 |
| 1.28 | | 4 | a*N1*2 |
| 2.56 | | 3 | a*N1*2 |

Note 1:
Applies for UE supporting power class 2&3&4. For UE supporting power class 1 or 5, N1 = 8 for all DRX cycle length.

The above various embodiments of the present disclosure may have partial impact to the current specification. For intra-frequency and inter-frequency RRM measurement, the similar update may be applied. For example, the current specification may be updated as follows in view of the above various embodiments of the present disclosure.
The UE shall be able to identify new intra-frequency cells and perform SS-RSRP and SS-RSRQ measurements of the identified intra-frequency cells without an explicit intra-frequency neighbour list containing physical layer cell identities.
The UE shall be able to evaluate whether a newly detectable intra-frequency cell meets the reselection criteria defined in TS38.304 within T_{detect,NR_Intra} when that T_{reselection}=0. An intra frequency cell is considered to be detectable according to the conditions defined in Annex B.1.2 for a corresponding Band.
The UE shall measure SS-RSRP and SS-RSRQ at least every T_{measure,NR_Intra} (see table 4.2.2.3-1 or table 4.2.2.3-2) for intra-frequency cells that are identified and measured according to the measurement rules.
The UE shall filter SS-RSRP and SS-RSRQ measurements of each measured intra-frequency cell using at least 2 measurements. Within the set of measurements used for the filtering, at least two measurements shall be spaced by at least T_{measure,NR_Intra}/2.
For an intra-frequency cell that has been already detected, but that has not been reselected to, the filtering shall be such that the UE shall be capable of evaluating that the intra-frequency cell has met reselection criterion defined in TS38.304 within T_{evaluate,NR_Intra} when T_{reselection}=0 as specified in table 4.2.2.3-1 or table 4.2.2.3-2 provided that:

TABLE 4.2.2.3-1
T_{detect, NR}_Intra, T_{measure, NR}_Intra, and T_{evaluate, NR}_Intra

| DRX | | | | | |
|---|---|---|---|---|---|
| cycle | Scaling Factor | | T_{detect, NR}_Intra [s] | T_{measure, NR}_Intra [s] | T_{evaluate, NR}_Intra [s] |
| length | (N1) | | (number of DRX | (number of DRX | (number of DRX |
| [s] | FR1 | FR2^{Note1} | cycles) | cycles) | cycles) |
| 0.32 | 1 | 8 | a*11.52 * N1 * M2 | a*1.28 * N1 * M2 | a*5.12 * N1 * M2 |
| | | | (a*36 * N1 * M2) | (a*4 * N1 * M2) | (a*16 * N1 * M2) |
| 0.64 | | 5 | a*17.92 * N1 (a*28 | a*1.28 * N1 (a*2 * | a*5.12 * N1 (a*8 * |
| | | | * N1) | N1) | N1) |
| 1.28 | | 4 | a*32 * N1 (a*25 * | a*1.28 * N1 (a*1 * | a*6.4 * N1 (a*5 * |
| | | | N1) | N1) | N1) |
| 2.56 | | 3 | a*58.88 * N1 (a*23 | a*2.56 * N1 (a*1 * | a*7.68 * N1 (a*3 * |
| | | | * N1) | N1) | N1) |

Note 1:
Applies for UE supporting power class 2&3&4. For UE supporting power class 1 or 5, N1 = 8 for all DRX cycle length.
Note 2:
M2 = 1.5 if SMTC periodicity of measured intra-frequency cell > 20 ms; otherwise M2 = 1. If different SMTC periodicities are configured for different cells, the SMTC periodicity in this note is the one used by the cell being identified. During PSS/SSS detection, the periodicity of the SMTC configured for the intra-frequency carrier is assumed, and if the actual SSB transmission periodicity is greater than the SMTC configured for the intra-frequency carrier, longer T_{detect, NR}_intra is expected.

It is understood that some example update to the specification are listed above only for the purpose of illustration without suggesting any limitation as to the scope of the disclosure, some other update may also be applied. For example, the scaling factor (a) is applied on all the durations shown in Table 4.2.2.2-1 and Table 4.2.2.3-1, however, in some other examples, the scaling factor (a) may only applied on one or several of the durations. Additionally, it is understood that the Scaling Factor (N1) show in Table 4.2.2.2-1 and Table 4.2.2.3-1 is different from the scaling factor (a) in the present disclosure.

Based on the example embodiments with reference to FIG. 3, the terminal device 120 may determine a measurement duration based on a scaling factor if a LP-WUS is configured, and thus the measurement duration may be longer. Accordingly, the terminal device may perform a measurement with a longer duration rather than a short one, therefore some unnecessary measurements may be avoided at the terminal deice. As such, the power consumption may be further reduced at the terminal device. Additionally, it is understood that the present disclosure may be applied to any type of terminal devices, including but not limit in power limited devices.

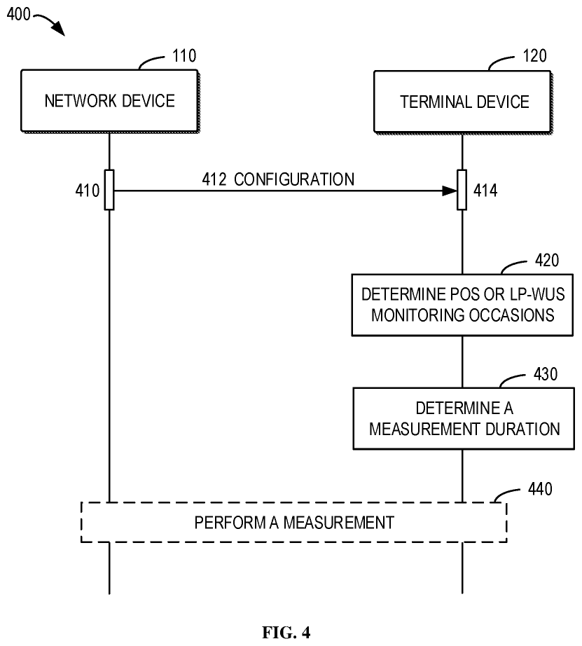

Reference is further made to FIG. 4, which illustrates a signalling chart illustrating communication process 400 in accordance with some example embodiments of the present disclosure. Only for the purpose of discussion, the process 400 will be described with reference to FIG. 1. The process 400 may involve the network device 110 and the terminal device 120.

The network device 110 transmits 410 a configuration 412 to the terminal device 120. The configuration 412 may indicate a first DRX cycle length and a second DRX cycle length.

In some example embodiments, the second DRX cycle length may be longer than the first DRX cycle length. In some examples, the second DRX cycle length may be integer multiple of the first DRX cycle length. For example, the first DRX cycle length may be represented as CL1, the second DRX cycle length may be represented as CL2, and CL2/CL1 equals to a positive integer greater than 1.

In some example embodiments, the first DRX cycle length may be only valid if a low power wake up signal is configured or if a periodicity of paging occasions is greater than a density threshold (i.e., a dense PO is configured).

In some example embodiments, the second DRX cycle length may be only valid if a low power wake up signal is not configured or if a periodicity of paging occasions is smaller or not greater than a density threshold (i.e., a dense PO is configured).

In some other example embodiments, the second DRX cycle length may be valid regardless of whether a low power wake up signal is configured or whether a periodicity of paging occasions is greater than a density threshold (i.e., a dense PO is configured).

On the other side of communication, the terminal device 120 receives 414 the configuration. Accordingly, the terminal device 120 may obtain the first DRX cycle length and a second DRX cycle length.

The terminal device 120 determines 420 POs or low power wake up signal monitoring occasions based on the first DRX cycle length and/or the second DRX cycle length. In some example embodiments, the first DRX cycle length may be only valid if a low power wake up signal is configured or if a periodicity of paging occasions is greater than a density threshold (i.e., a dense PO is configured), and the terminal device 120 may determine the POs or low power wake up signal monitoring occasions based on the first DRX cycle length. In some other example embodiments, the second DRX cycle length may be only valid if a low power wake up signal is not configured or if a periodicity of paging occasions is smaller or not greater than a density threshold (i.e., a dense PO is configured), and the terminal device 120 may determine the POs based on the second DRX cycle length. In some other example embodiments, the second DRX cycle length may be valid regardless of whether a low power wake up signal is configured or whether a periodicity of paging occasions is greater than a density threshold (i.e., a dense PO is configured), and the terminal device 120 may determine the POs or low power wake up signal monitoring occasions based on the first DRX cycle length and the second DRX cycle length.

The terminal device 120 determines 430 a measurement duration based on the second DRX cycle length.

In addition or alternatively, the terminal device 120 may perform 440 a measurement based on the measurement duration.

As such, a second DRX cycle length greater than a first DRX cycle length may be configured and the second DRX cycle length may be used for determining the measurement duration. Thus, the measurement duration may be longer and unnecessary measurement may be avoided. Therefore, the power consumption may be further reduced at the terminal device.

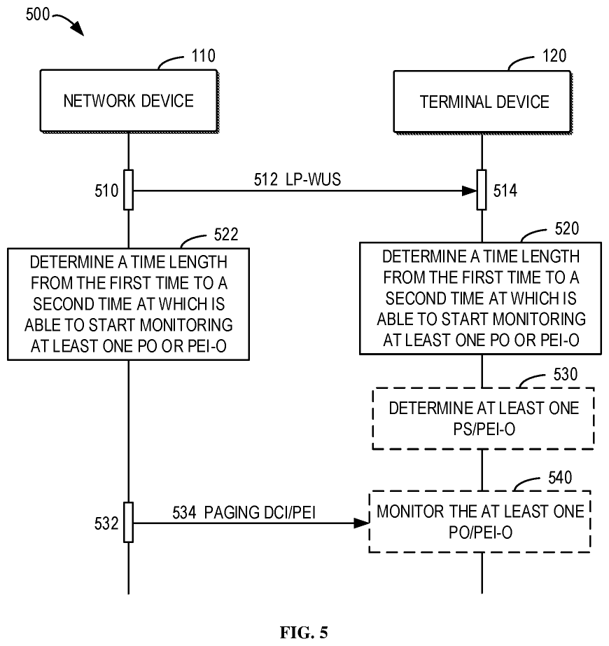

Reference is further made to FIG. 5, which illustrates a signalling chart illustrating communication process 500 in accordance with some example embodiments of the present disclosure. Only for the purpose of discussion, the process 500 will be described with reference to FIG. 1. The process 500 may involve the network device 110 and the terminal device 120.

The network device 110 transmits 510 a low power wake up signal 512 to the terminal device 120. Accordingly, the terminal device 120 receives 514 the low power wake up signal 512. It is assumed that the low power wake up signal 512 is received by the terminal device 120 at a first time, which may be represented as t1.

In some example embodiments, the first time (t1) may be based on a time unit when the terminal device 120 receives the low power wake up signal, the time unit may be a symbol, a subframe, a frame or a slot. In some examples, the first time may be a starting time point of the time unit for receiving the low power wake up signal, or may be an ending time point of the time unit for receiving the low power wake up signal. In other words, the first time may be the start or the end of the time unit when the terminal device 120 receives the low power wake up signal. In some examples, the first time may be an index of the time unit, for example, (t1) may be a subframe index or a slot index.

The terminal device 120 determines 520 a time length from the first time to a second time at which the terminal device 120 is able to start monitoring at least one paging occasion (PO) or at least one paging early indication occasion (PEI-O). For ease of description, the second time may be represented as t2, and the time length may be represented as T, and t2=t1+T. In some example embodiments, the time length (T) may be determined based on an RRC configuration from the network device 110 and/or the capability of the terminal device 120. In some example embodiments, the time length (T) may be a value in unit of second or millisecond, or the time length (T) may be a number of symbols, slots, subframes or frames.

In some example embodiments, the terminal device 120 is not required to monitor the PO or PEI-O before the second time (t2). In other words, the second time may be an earliest time that the terminal device 120 can start the PO or PEI-O monitoring. That is, the terminal device 120 is not required to monitor the PO or PEI-O before the second time.

In some example embodiments, the time length may be determined based on one or more of: a processing time of the low power wake up signal, a feedback delay of acknowledge of the low power wake up signal, an activation time of a main radio of the terminal device, a time duration to an end of a complete SSB burst, a processing time of SSB, whether an SSB measurement is required, or whether an SSB associated with the monitoring of the at least one PO/PEI-O is known to the terminal device 120.

In some embodiments, if one or more of the following conditions are met, the terminal device 120 may determine that the time length is a first time length: (1-1) the terminal device 120 is not required to perform SSB measurement after receiving the low power wake up signal and before monitoring the at least one PO or PEI-O; (1-2) an SSB associated with the monitoring of the at least one PO or PEI-O is known to the terminal device 120; (1-3) an operating band of the terminal device belongs to frequency range 1 (FR1); (1-4) a number of configured SSB is 1; or (1-5) there is one receiver (RX) beam at the terminal device 120.

In some examples, the first time length may be represented as T1, where T1=T03 or T1=T02+T03. T02 may represent a processing time of the low power wake up signal at the terminal device 120. For example, T02 may be less than 1 ms. T03 may represent at least one of: a feedback delay of acknowledge of the low power wake up signal, or an activation time of a main radio of the terminal device 120. For example, if the feedback of the low power wake up signal is configured, T03 may comprise the feedback delay of acknowledge of the low power wake up signal. For example, the activation time of the main radio may be a hardware activation time, that is, an activation delay of the main radio. In some examples, the activation delay of the main radio may be associated with the transceiver or the receiver only. For example, T03 may be multiple milliseconds. It is understood that since T02<<T03, T02 may be negligible, and T1=T03.

In some examples, the condition (1-1) may be based on a configuration from the network device 110, for example, the network device 110 may notify the terminal device 120 not to perform the SSB measurement through an RRC message. In some other examples, the condition (1-1) may be based on the terminal device 120's own decision, for example, the terminal device 120 may determine not to perform the SSB measurement according to its capability. This may imply that the SSB measurement or maintenance for PO/PEI-O monitoring is up to UE implementation, the terminal device 120 should be able to monitor PO/PEI-O without a dedicated SSB measurement after the detection of the low power wake up signal.

In some examples, the condition (1-2) may refer that an SSB associated with PO/PEI-O monitoring is known to the terminal device 120, which may include an SSB index and/or a proper RX beam of the SSB.

In some examples, the condition (1-4) may refer that there is only one SSB configured. In some examples, the condition (1-5) may refer that there is only one RX beam at the terminal device 120, in other words, the RX beam number is 1.

In some embodiments, if one or more of the following conditions are met, the terminal device 120 may determine that the time length is a second time length: (2-1) the terminal device 120 is required to perform SSB measurement after receiving the low power wake up signal and before monitoring the at least one PO or PEI-O; (2-2) an SSB associated with the monitoring of the at least one PO or PEI-O is unknown to the terminal device 120; (2-3) an operating band of the terminal device does not belong to FR1; (2-4) a number of configured SSB is more than 1; or (2-5) there is more than one RX beam at the terminal device 120.

In some examples, the second time length is longer than the first time length. The second time length may be represented as T2, T2>T1, for example, T2=T1+T04+T05. With reference to the first time length described above, T2=T03+T04+T05 or T2=T02+T03+T04+T05. T02 may represent a processing time of the low power wake up signal at the terminal device 120. T03 may represent at least one of: a feedback delay of acknowledge of the low power wake up signal, or an activation time of a main radio of the terminal device 120.

In some examples, T04 may represent a time duration from an ending time of an activation of a main radio to an end of a complete SSB burst. For example, the complete SSB burst may refer to the first complete SSB burst after the main radio is activated. For another example, the complete SSB burst may refer to the Nth complete SSB burst after the main radio is activated, where N is an integer and is related with the operating band. For example, N may be greater for NR2 comparing with that for FR1. For example, N may be greater than 1 for FR2 and N may equal 1 for FR1.

In some examples, T05 may represent a processing time of SSB. For example, T05 may be multiple milliseconds, such as 2 ms or 5 ms.

In some examples, the condition (2-1) may be based on a configuration from the network device 110, for example, the network device 110 may notify the terminal device 120 to perform the SSB measurement through an RRC message. In some other examples, the condition (2-1) may be based on the terminal device 120's own decision, for example, the terminal device 120 may determine to perform the SSB measurement according to its capability. This may imply that the SSB measurement or maintenance for PO/PEI-O monitoring is up to UE implementation.

In some examples, the condition (2-3) may refer that an operating band of the terminal device 120 may belong to FR2 or FR2-2. In some examples, the condition (2-4) may refer that there is more than one SSB configured, that is the configured SSB number is larger than 1. In some examples, the condition (2-5) may refer that there is more than 1 RX beam at the terminal device 120, in other words, the RX beam number is larger than 1.

It is understood that before the terminal device 120 starts monitoring a PO, it may have to perform SSB measurement to refine its time or frequency synchronization and the receiving beam, if any. This means the time duration from wake-up to the start of a PO should be long enough to allow the terminal device 120 to finish the SSB measurement. Based on the embodiments described in the present disclosure, the time length is determined by considering the SSB measurement, and thus the terminal device 120 may determine appropriate time resource for monitoring PO/PEI-O.

Continue referring to FIG. 5, in addition or alternatively, the terminal device 120 may determine 530 at least one PO/PEI-O to be monitored after the second time. In addition or alternatively, the terminal device 120 may monitor 540 the at least one PO/PEI-O.

In some example embodiments, the at least one PO/PEI-O to be monitored may include the first PO/PEI-O which starts no later than the second time (t2). For example, the second time may be t1+T1 or t1+T2, the description of T1 and T2 may refer to those embodiments stated above. In some examples, the at least one PO/PEI-O to be monitored may include one PO/PEI-O with a starting time no later than the second time.

In some example embodiments, the at least one PO/PEI-O to be monitored may include multiple POs/PEI-Os between t1+T1 and t1+T3. T3 is longer than T1, and alternatively, T3 is longer than T2, and the description of T1 and T2 may refer to those embodiments stated above. In some examples, T3 may be determined based on T2, for example, t1+T3 may be the start or the end of the first or Nth PO/PEI-O after t1+T2.

In some examples, the terminal device 120 may monitor the multiple POs/PEI-Os between t1+T1 and t1+T3. In some examples, the terminal device 120 may stop monitoring the remaining POs if a paging DCI is detected in one of the multiple POs or if paging information is received. In some examples, the terminal device 120 may stop monitoring the remaining PEI-Os if a PEI is detected in one of the multiple PEI-Os. In some examples, the terminal device 120 may stop monitoring the remaining POs/PEI-Os after successfully detecting a PDCCH with cyclic redundancy check (CRC) scrambled by paging-radio network temporary identity (P-RNTI) in a PO/PEI-O or receiving paging information which matches an identity of the terminal device 120. In some examples, the paging DCI is transmitted by a PDCCH with CRC scrambled by P-RNTI. In some examples, the paging DCI is used to schedule a PDSCH or to transmit a Short Message.

In some example embodiments, the at least one PO/PEI-O to be monitored may include two POs/PEI-Os, i.e., a first PO/PEI-O and a second PO/PEI-O. The first PO/PEI-O is after t1+T1, the second PO/PEI-O is after t1+T2, and the description of T1 and T2 may refer to those embodiments stated above. In some examples, the first PO/PEI-O is between t1+T1 and t1+T2.

In some examples, the terminal device 120 may monitor the first PO/PEI-O and the second PO/PEI-O. In some examples, if the terminal device 120 needs to perform SSB measurement, then the terminal device 120 may skip the first PO/PEI-O; and the terminal device 120 may monitor the second PO/PEI-O. In some examples, the terminal device 120 map skip the first PO/PEI-O if the terminal device 120 has to measure SSB.

In some examples, the terminal device 120 may stop monitor the second PO/PEI-O if successfully detecting a PDCCH with CRC scrambled by P-RNTI in the PO/PEI-O or receiving paging information which matches its identity. In some examples, if a paging DCI is detected in the first PO, or if a PEI is detected in the first PEI-O, or if paging information is received, the terminal device 120 may stop monitoring the second PO/PEI-O.

On the other side of communication, the network device 110 determines 522 the time length from the first time to a second time at which the terminal device 120 is able to start monitoring at least one PO/PEI-O. In some examples, the determination at the network device 110 is similar with that at the terminal device 120, and thus will not be repeated herein.

The network device 110 transmits 532 a paging DCI or PEI 534. Specifically, the network device 110 may transmit the paging DCI in the at least one PO or transmit the PEI in the at least one PEI-O.

In some examples, the network device 110 may transmit the paging DCI in a first PO, and further transmit the paging DCI in a second PO after the first PO. In some examples, if the network device 110 receives a response of the paging DCI which is transmitted in the first PO, then the network device 110 may stop transmitting the paging DCI in a second PO. In some examples, the response of the paging DCI refers to a random access procedure performed by the terminal device 120 which is paged.

In some examples, the network device 110 may transmit the PEI in a first PEI-O, and further transmit the PEI in a second PEI-O after the first PEI-O. In some examples, if the network device 110 receives a response of the PEI which is transmitted in the first PEI-O, then the network device 110 may stop transmitting the PEI in a second PEI-O.

In some embodiments, the response may be implemented as a random access initiated by the terminal device 120.

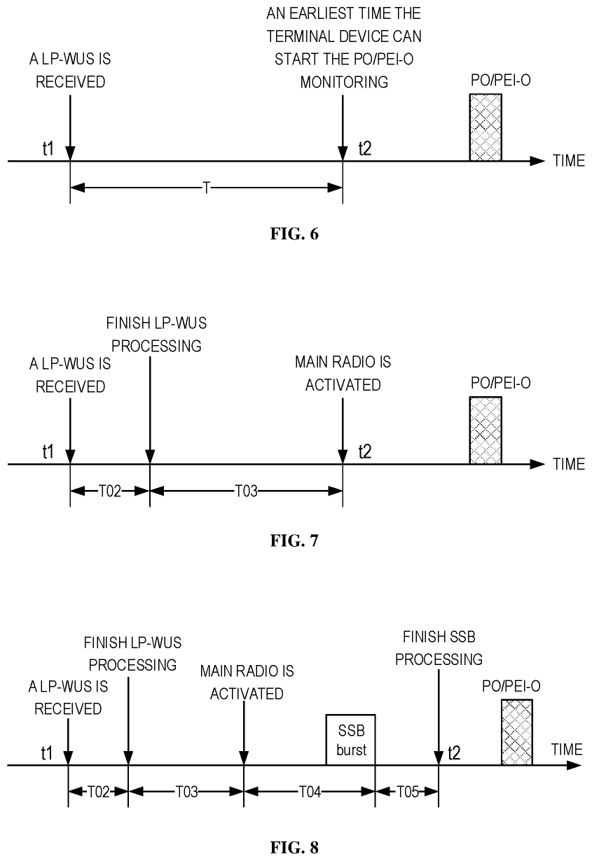

FIG. 6 illustrates a schematic diagram of a time length according to some embodiments of the present disclosure. As shown in FIG. 6, the time length (T) is from a first time (t1) to a second time (t2), where t1 represents a time when a LP-WUS is received, and t2 represents an earliest time that the terminal device 120 can start the PO/PEI-O monitoring.

FIG. 7 illustrates a schematic diagram of a time length according to some embodiments of the present disclosure. As shown in FIG. 7, the time length from a first time (t1) to a second time (t2) includes T02 and T03, where T02 represents a processing time of the LP-WUS and T03 represents an activation time of the main radio.

FIG. 8 illustrates a schematic diagram of a time length according to some embodiments of the present disclosure. As shown in FIG. 8, the time length from a first time (t1) to a second time (t2) includes T02, T03, T04 and T05, where T02 represents a processing time of the LP-WUS, T03 represents an activation time of the main radio, T04 represents a time duration from an ending time of an activation of a main radio to an end of a complete SSB burst, and T05 represents a processing time of SSB.

As such, the terminal device 120 may determine a time length after which it is able to monitor PO/PEI-O, accordingly the terminal device 120 and the network device 110 may determine appropriate time domain resource for the low power wake up signal and the associated PO/PEI-O. Specifically, due to the LP-WUS mechanism, the terminal device 120 does not need to monitor all the POs/PEI-Os and the network device 110 also does not need to transmit in all the POs/PEI-Os, the overhead and power consumption at the terminal device 120 are not increased, and thus the communication resource may be utilized efficiently.

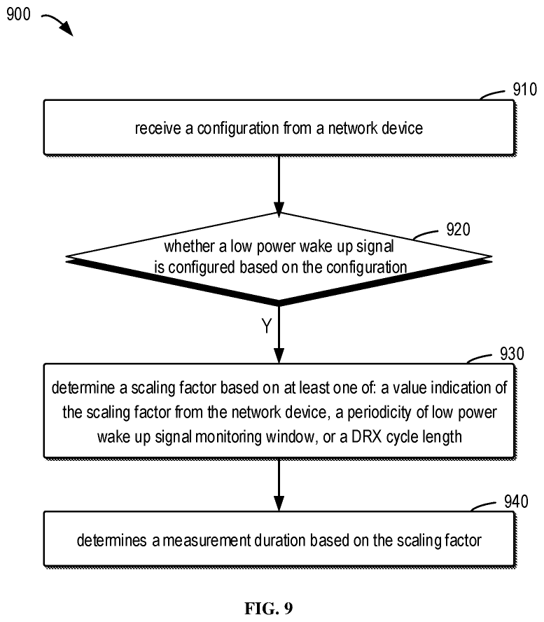

FIG. 9 illustrates a flowchart of an example method 900 implemented at a terminal device in accordance with some embodiments of the present disclosure. For the purpose of discussion, the method 900 will be described from the perspective of the terminal device 120 with reference to FIG. 1.

At block 910, the terminal device 120 receives a configuration from a network device 110. At block 920, the terminal device 120 determines whether a low power wake up signal is configured based on the configuration. At block 930, if the low power wake up signal is configured, the terminal device 120 determines a scaling factor based on at least one of: a value indication of the scaling factor from the network device, a periodicity of low power wake up signal monitoring window, or a DRX cycle length. At block 940, the terminal device 120 determines a measurement duration based on the scaling factor.

In some example embodiments, if the low power wake up signal is configured and at least one of the following conditions is met, the terminal device 120 determines the scaling factor, where the conditions include: a periodicity of paging occasions is greater than a density threshold, or the DRX cycle length is smaller than a length threshold.

In some example embodiments, if the low power wake up signal is not configured, the terminal device 120 determines that the scaling factor is 1 or the scaling factor is not applied for the measurement duration.

In some example embodiments, the measurement duration is further based on a further duration, the further duration is based on at least one of: the DRX cycle length, a synchronization signal block (SSB)-based radio resource management (RRM) measurement timing configuration (SMTC) periodicity, or a frequency range.

In some example embodiments, the measurement duration comprises at least one of: a synchronization signal-reference signal received power (SS-RSRP) measurement duration, a synchronization signal-reference signal received quality (SS-RSRQ) measurement duration, a detection duration, or an evaluation duration.

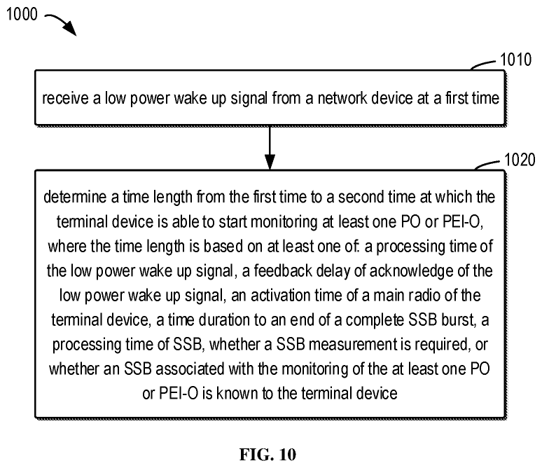

FIG. 10 illustrates a flowchart of an example method 1000 implemented at a terminal device in accordance with some embodiments of the present disclosure. For the purpose of discussion, the method 1000 will be described from the perspective of the terminal device 120 with reference to FIG. 1.

At block 1010, the terminal device 120 receives a low power wake up signal from a network device 110 at a first time. At block 1020, the terminal device 120 determines a time length from the first time to a second time at which the terminal device is able to start monitoring at least one PO or PEI-O, where the time length is based on at least one of: a processing time of the low power wake up signal, a feedback delay of acknowledge of the low power wake up signal, an activation time of a main radio of the terminal device, a time duration to an end of a complete SSB burst, a processing time of SSB, whether an SSB measurement is required, or whether an SSB associated with the monitoring of the at least one PO or PEI-O is known to the terminal device.

In some example embodiments, the terminal device 120 determines that the time length is a first time length based on at least one of the conditions: the terminal device is not required to perform SSB measurement after receiving the low power wake up signal and before monitoring the at least one PO or PEI-O, an SSB associated with the monitoring of the at least one PO or PEI-O is known to the terminal device, an operating band of the terminal device belongs to frequency range 1 (FR1), a number of configured SSB is 1, or there is one receiver (RX) beam at the terminal device.

In some example embodiments, the terminal device 120 determines that the time length is a second time length based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operating band of the terminal device does not belong to FR1, a number of configured SSB is more than 1, or there is more than one RX beam at the terminal device, where the second time length comprises a first time length and the second time length is longer than the first time length.

In some example embodiments, the second time length further comprises: a time duration from an ending time of an activation of a main radio to an end of a complete SSB burst, and a processing time of SSB.

In some example embodiments, the first time length comprises at least one of: a feedback delay of acknowledge of the low power wake up signal, or an activation time of a main radio of the terminal device.

In some example embodiments, the first time length further comprises a processing time of the low power wake up signal.

In some example embodiments, the terminal device 120 determines that the at least one PO or PEI-O to be monitored comprises a PO or a PEI-O with a starting time no later than the second time.

In some example embodiments, the terminal device 120 determines that the at least one PO or PEI-O to be monitored comprises a plurality of POs or PEI-Os during a time period between the second time and a third time, a first time length from the first time to the third time being longer than a second time length from the first time to a fourth time, the second time length being determined based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operation band of the terminal device is not FR1, a number of configured SSB is more than 1, or there is more than one RX beam at the terminal device.

In some example embodiments, the third time is based on the first PO or PEI-G after the fourth time.

In some example embodiments, the terminal device 120 monitors the plurality of POs or PEI-Os during the time period; and if paging downlink control information (DCI) is detected in one of the plurality of POs or a PEI is detected in one of the plurality of PEI-Os or paging information is received, the terminal device 120 stops the monitoring.

In some example embodiments, the terminal device 120 determines that the at least one PO or PEI-G to be monitored comprises a first PO or PEI-G and a second PO or PEI-O, the first PO or PEI-G being a PO or PEI-G after the second time, the second PO or PEI-G being a PO or PEI-G after a fourth time, a second time length from the first time to the fourth time being determined based on at least one of the conditions: the terminal device is required to perform SSB measurement after receiving the low power wake up signal and before monitoring the at least one PO or PEI-O, an SSB associated with the monitoring of the at least one PO or PEI-G is unknown to the terminal device, an operation band of the terminal device is not FR1, a number of configured SSB is more than 1, or there is more than one RX beam at the terminal device.

In some example embodiments, the terminal device 120 monitors the first PO or PEI-O and the second PO or PEI-O; and if a paging DCI is detected in the first PO or a PEI is detected in the first PEI-G or paging information is received, the terminal device 120 stops monitoring the second PO or PEI-O.

In some example embodiments, if the terminal device 120 needs to perform SSB measurement, the terminal device 120 skips the first PO or PEI-O; and monitors the second PO or PEI-O.

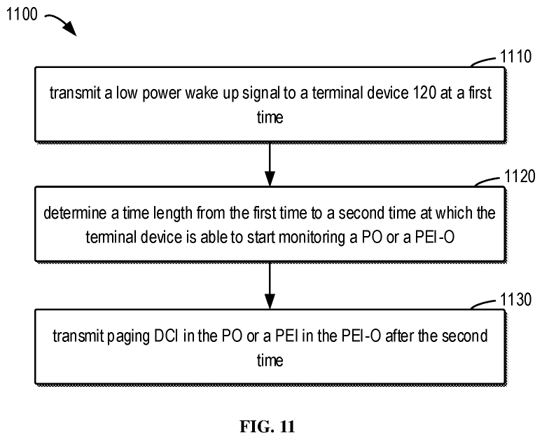

FIG. 11 illustrates a flowchart of an example method 1100 implemented at a network device in accordance with some embodiments of the present disclosure. For the purpose of discussion, the method 1100 will be described from the perspective of the network device 110 with reference to FIG. 1.

At block 1110, the network device 110 transmits a low power wake up signal to a terminal device 120 at a first time. At block 1120, the network device 110 determines a time length from the first time to a second time at which the terminal device 120 is able to start monitoring a PO or a PEI-O. At block 1130, the network device 110 transmits paging DCI in the PO or a PEI in the PEI-O after the second time.

In some example embodiments, the network device 110 transmits the paging DCI in a first PO; and transmits the paging DCI in a second PO after the first PO.

In some example embodiments, if receiving a response of the paging DCI transmitted in the first PO from the terminal device 120, the network device 110 stops the transmission in the second PO

In some example embodiments, the network device 110 transmits the PEI in a first PEI-O; and transmits the PEI in a second PEI-O after the first PEI-O.

In some example embodiments, if receiving a response of the PEI transmitted in the first PEI-O from the terminal device 120, the network device 110 stops the transmission in the second PEI-O.

Details of some embodiments according to the present disclosure have been described with reference to FIGS. 1-11. Now an example implementation of the terminal device and the network device will be discussed below.

In some example embodiments, a terminal device comprises circuitry configured to: receives a configuration from a network device; determine whether a low power wake up signal is configured based on the configuration; if the low power wake up signal is configured, determine a scaling factor based on at least one of: a value indication of the scaling factor from the network device, a periodicity of low power wake up signal monitoring window, or a DRX cycle length; and determine a measurement duration based on the scaling factor.

In some example embodiments, the terminal device comprises circuitry configured to: if the low power wake up signal is configured and at least one of the following conditions is met, determine the scaling factor, where the conditions include: a periodicity of paging occasions is greater than a density threshold, or the DRX cycle length is smaller than a length threshold.

In some example embodiments, the terminal device comprises circuitry configured to: if the low power wake up signal is not configured, determine that the scaling factor is 1 or the scaling factor is not applied for the measurement duration.

In some example embodiments, the measurement duration is further based on a further duration, the further duration is based on at least one of: the DRX cycle length, a synchronization signal block (SSB)-based radio resource management (RRM) measurement timing configuration (SMTC) periodicity, or a frequency range.

In some example embodiments, the measurement duration comprises at least one of: a synchronization signal-reference signal received power (SS-RSRP) measurement duration, a synchronization signal-reference signal received quality (SS-RSRQ) measurement duration, a detection duration, or an evaluation duration.

In some example embodiments, a terminal device comprises circuitry configured to: receive a low power wake up signal from a network device at a first time; determine a time length from the first time to a second time at which the terminal device is able to start monitoring at least one PO or PEI-O, where the time length is based on at least one of: a processing time of the low power wake up signal, a feedback delay of acknowledge of the low power wake up signal, an activation time of a main radio of the terminal device, a time duration to an end of a complete SSB burst, a processing time of SSB, whether an SSB measurement is required, or whether an SSB associated with the monitoring of the at least one PO or PEI-O is known to the terminal device.

In some example embodiments, the terminal device comprises circuitry configured to: determine that the time length is a first time length based on at least one of the conditions: the terminal device is not required to perform SSB measurement after receiving the low power wake up signal and before monitoring the at least one PO or PEI-O, an SSB associated with the monitoring of the at least one PO or PEI-O is known to the terminal device, an operating band of the terminal device belongs to frequency range 1 (FR1), a number of configured SSB is 1, or there is one receiver (RX) beam at the terminal device.

In some example embodiments, the terminal device comprises circuitry configured to: determine that the time length is a second time length based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operating band of the terminal device does not belong to FR1, a number of configured SSB is more than 1, or there is more than one RX beam at the terminal device, where the second time length comprises a first time length and the second time length is longer than the first time length.

In some example embodiments, the second time length further comprises: a time duration from an ending time of an activation of a main radio to an end of a complete SSB burst, and a processing time of SSB.

In some example embodiments, the first time length comprises at least one of: a feedback delay of acknowledge of the low power wake up signal, or an activation time of a main radio of the terminal device.

In some example embodiments, the first time length further comprises a processing time of the low power wake up signal.

In some example embodiments, the terminal device comprises circuitry configured to: determine that the at least one PO or PEI-O to be monitored comprises a PO or a PEI-O with a starting time no later than the second time.

In some example embodiments, the terminal device comprises circuitry configured to: determine that the at least one PO or PEI-O to be monitored comprises a plurality of POs or PEI-Os during a time period between the second time and a third time, a first time length from the first time to the third time being longer than a second time length from the first time to a fourth time, the second time length being determined based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operation band of the terminal device is not FR1, a number of configured SSB is more than 1, or there is more than one RX beam at the terminal device.

In some example embodiments, the third time is based on the first PO or PEI-O after the fourth time.

In some example embodiments, the terminal device comprises circuitry configured to: monitor the plurality of POs or PEI-Os during the time period; and if paging downlink control information (DCI) is detected in one of the plurality of POs or a PEI is detected in one of the plurality of PEI-Os or paging information is received, stop the monitoring.

In some example embodiments, the terminal device comprises circuitry configured to: determine that the at least one PO or PEI-O to be monitored comprises a first PO or PEI-O and a second PO or PEI-O, the first PO or PEI-O being a PO or PEI-O after the second time, the second PO or PEI-O being a PO or PEI-O after a fourth time, a second time length from the first time to the fourth time being determined based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operation band of the terminal device is not FR1, a number of configured SSB is more than 1, or there is more than one RX beam at the terminal device.

In some example embodiments, the terminal device comprises circuitry configured to: monitor the first PO or PEI-O and the second PO or PEI-O; and if a paging DCI is detected in the first PO or a PEI is detected in the first PEI-O or paging information is received, stop monitoring the second PO or PEI-O.

In some example embodiments, the terminal device comprises circuitry configured to: if the terminal device needs to perform SSB measurement, skip the first PO or PEI-O; and monitors the second PO or PEI-O.

In some example embodiments, a network device comprises circuitry configured to: transmit a low power wake up signal to a terminal device 120 at a first time; determine a time length from the first time to a second time at which the terminal device is able to start monitoring a PO or a PEI-O; and transmit paging DCI in the PO or a PEI in the PEI-O after the second time.

In some example embodiments, the network device comprises circuitry configured to: transmit the paging DCI in a first PO; and transmit the paging DCI in a second PO after the first PO.

In some example embodiments, the network device comprises circuitry configured to: if receiving a response of the paging DCI transmitted in the first PO from the terminal device, stop the transmission in the second PO

In some example embodiments, the network device comprises circuitry configured to: transmit the PEI in a first PEI-O; and transmit the PEI in a second PEI-O after the first PEI-O.

In some example embodiments, the network device comprises circuitry configured to: if receiving a response of the PEI transmitted in the first PEI-O from the terminal device, stop the transmission in the second PEI-O.

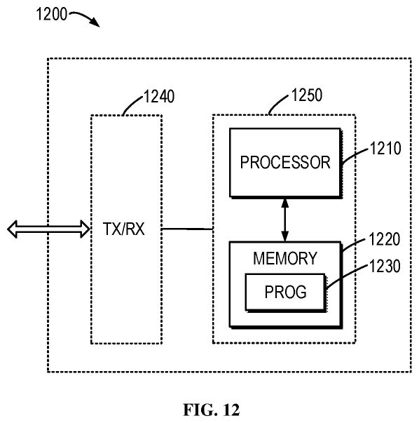

FIG. 12 illustrates a simplified block diagram of a device 1200 that is suitable for implementing embodiments of the present disclosure. The device 1200 can be considered as a further example implementation of the terminal device 120, and the network device 110 as shown in FIG. 1. Accordingly, the device 1200 can be implemented at or as at least a part of the terminal device 120, or the network device 110.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 2-11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device, a configuration from a network device; determining whether a low power wake up signal is configured based on the configuration; in accordance with a determination that the low power wake up signal is configured, determining a scaling factor based on at least one of: a value indication of the scaling factor from the network device, a periodicity of low power wake up signal monitoring window, or a discontinuous reception (DRX) cycle length; and determining a measurement duration based on the scaling factor.

In one embodiment, the method as above, determining the scaling factor comprises: in accordance with a determination that the low power wake up signal is configured and at least one of the following conditions, determining the scaling factor: a periodicity of paging occasions is greater than a density threshold, or the DRX cycle length is smaller than a length threshold.

In one embodiment, the method as above, further comprising: in accordance with a determination that the low power wake up signal is not configured, determining the scaling factor being 1 or the scaling factor is not applied for the measurement duration.

In one embodiment, the method as above, the measurement duration is further based on a further duration, the further duration is based on at least one of: the DRX cycle length, a synchronization signal block (SSB)-based radio resource management (RRM) measurement timing configuration (SMTC) periodicity, or a frequency range.

In one embodiment, the method as above, the measurement duration comprises at least one of: a synchronization signal-reference signal received power (SS-RSRP) measurement duration, a synchronization signal-reference signal received quality (SS-RSRQ) measurement duration, a detection duration, or an evaluation duration.

The present disclosure provides a method of communication, comprises: receiving, at a terminal device, a low power wake up signal from a network device at a first time; determining a time length from the first time to a second time at which the terminal device is able to start monitoring at least one paging occasion (PO) or paging early indication occasion (PEI-O), the time length being based on at least one of: a processing time of the low power wake up signal, a feedback delay of acknowledge of the low power wake up signal, an activation time of a main radio of the terminal device, a time duration to an end of a complete synchronization signal block (SSB) burst, a processing time of SSB, whether an SSB measurement is required, or whether an SSB associated with the monitoring of the at least one PO or PEI-O is known to the terminal device.

In one embodiment, the method as above, determining a time length comprises: determining that the time length is a first time length based on at least one of the conditions: the terminal device is not required to perform SSB measurement after receiving the low power wake up signal and before monitoring the at least one PO or PEI-O, an SSB associated with the monitoring of the at least one PO or PEI-O is known to the terminal device, an operating band of the terminal device belongs to frequency range 1 (FR1), a number of configured SSB is 1, or there is one receiver (RX) beam at the terminal device.

In one embodiment, the method as above, determining a time length comprises: determining that the time length is a second time length based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operating band of the terminal device does not belong to FR1, a number of configured SSB is more than 1, or there is more than one RX beam at the terminal device, wherein the second time length comprises a first time length and the second time length is longer than the first time length.

In one embodiment, the method as above, the second time length further comprises: a time duration from an ending time of an activation of a main radio to an end of a complete SSB burst, and a processing time of SSB.

In one embodiment, the method as above, the first time length comprises at least one of: a feedback delay of acknowledge of the low power wake up signal, or an activation time of a main radio of the terminal device.

In one embodiment, the method as above, the first time length further comprises a processing time of the low power wake up signal.

In one embodiment, the method as above, further comprising: determining that the at least one PO or PEI-O to be monitored comprises a PO or a PEI-O with a starting time no later than the second time.

In one embodiment, the method as above, further comprising: determining that the at least one PO or PEI-O to be monitored comprises a plurality of POs or PEI-Os during a time period between the second time and a third time, a first time length from the first time to the third time being longer than a second time length from the first time to a fourth time, the second time length being determined based on at least one of the conditions: the terminal device is required to perform SSB measurement after receiving the low power wake up signal and before monitoring the at least one PO or PEI-O, an SSB associated with the monitoring of the at least one PO or PEI-O is unknown to the terminal device, an operation band of the terminal device is not FR1, a number of configured SSB is more than 1, or there is more than one RX beam at the terminal device.

In one embodiment, the method as above, the third time is based on the first PO or PEI-O after the fourth time.

In one embodiment, the method as above, further comprising: monitoring the plurality of POs or PEI-Os during the time period; and in accordance with a determination that paging downlink control information (DCI) is detected in one of the plurality of POs or a PEI is detected in one of the plurality of PEI-Os or paging information is received, stopping the monitoring.

In one embodiment, the method as above, further comprising: determining that the at least one PO or PEI-O to be monitored comprises a first PO or PEI-O and a second PO or PEI-O, the first PO or PEI-O being a PO or PEI-O after the second time, the second PO or PEI-O being a PO or PEI-O after a fourth time, a second time length from the first time to the fourth time being determined based on at least one of the conditions: the terminal device is required to perform SSB measurement after receiving the low power wake up signal and before monitoring the at least one PO or PEI-O, an SSB associated with the monitoring of the at least one PO or PEI-G is unknown to the terminal device, an operation band of the terminal device is not FR1, a number of configured SSB is more than 1, or there is more than one RX beam at the terminal device.

In one embodiment, the method as above, further comprising: monitoring the first PO or PEI-O and the second PO or PEI-O; and in accordance with a determination that a paging DCI is detected in the first PO or a PEI is detected in the first PEI-G or paging information is received, stopping monitoring the second PO or PEI-O.

In one embodiment, the method as above, further comprising: in accordance with a determination that the terminal device needs to perform SSB measurement, skipping the first PO or PEI-O; and monitoring the second PO or PEI-O.

The present disclosure provides a method of communication, comprises: transmitting, at a network device, a low power wake up signal to a terminal device at a first time; determining a time length from the first time to a second time at which the terminal device is able to start monitoring a paging occasion (PO) or a paging early indication occasion (PEI-O); and transmitting paging downlink control information (DCI) in the PO or a PEI in the PEI-O after the second time.

In one embodiment, the method as above, transmitting the paging DCI comprises: transmitting the paging DCI in a first PO; and transmitting the paging DCI in a second PO after the first PO.

In one embodiment, the method as above, further comprising: in accordance with a reception of a response of the paging DCI transmitted in the first PO from the terminal device, stopping the transmission in the second PO.

In one embodiment, the method as above, transmitting the PEI comprises: transmitting the PEI in a first PEI-O; and transmitting the PEI in a second PEI-G after the first PEI-O.

In one embodiment, the method as above, further comprising: in accordance with a reception of a response of the PEI transmitted in the first PEI-G from the terminal device, stopping the transmission in the second PEI-O.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device, a configuration from a network device;
determining whether a low power wake up signal is configured based on the configuration;
in accordance with a determination that the low power wake up signal is configured, determining a scaling factor based on at least one of:
a value indication of the scaling factor from the network device,
a periodicity of low power wake up signal monitoring window, or
a discontinuous reception (DRX) cycle length; and
determining a measurement duration based on the scaling factor.

2. The method of claim 1, wherein determining the scaling factor comprises:
in accordance with a determination that the low power wake up signal is configured and at least one of the following conditions, determining the scaling factor:
a periodicity of paging occasions is greater than a density threshold, or
the DRX cycle length is smaller than a length threshold.

3. The method of claim 1, further comprising:
in accordance with a determination that the low power wake up signal is not configured, determining the scaling factor being 1 or the scaling factor is not applied for the measurement duration.

4. The method of claim 1, wherein the measurement duration is further based on a further duration, the further duration is based on at least one of:
the DRX cycle length,
a synchronization signal block (SSB)-based radio resource management (RRM) measurement timing configuration (SMTC) periodicity, or
a frequency range.

5. The method of claim 1, wherein the measurement duration comprises at least one of:
a synchronization signal-reference signal received power (SS-RSRP) measurement duration,
a synchronization signal-reference signal received quality (SS-RSRQ) measurement duration,
a detection duration, or
an evaluation duration.

6. A method of communication, comprising:
receiving, at a terminal device, a low power wake up signal from a network device at a first time;
determining a time length from the first time to a second time at which the terminal device is able to start monitoring at least one paging occasion (PO) or paging early indication occasion (PEI-O), the time length being based on at least one of:
a processing time of the low power wake up signal,
a feedback delay of acknowledge of the low power wake up signal,
an activation time of a main radio of the terminal device,
a time duration to an end of a complete synchronization signal block (SSB) burst,
a processing time of SSB,
whether an SSB measurement is required, or
whether an SSB associated with the monitoring of the at least one PO or PEI-O is known to the terminal device.

7. The method of claim 6, wherein determining a time length comprises:
determining that the time length is a first time length based on at least one of the conditions:
the terminal device is not required to perform SSB measurement after receiving the low power wake up signal and before monitoring the at least one PO or PEI-O,
an SSB associated with the monitoring of the at least one PO or PEI-O is known to the terminal device,
an operating band of the terminal device belongs to frequency range 1 (FR1),
a number of configured SSB is 1, or
there is one receiver (RX) beam at the terminal device.

8. The method of claim 6, wherein determining a time length comprises:
determining that the time length is a second time length based on at least one of the conditions:
the terminal device is required to perform SSB measurement after receiving the low power wake up signal and before monitoring the at least one PO or PEI-O,
an SSB associated with the monitoring of the at least one PO or PEI-O is unknown to the terminal device,
an operating band of the terminal device does not belong to FR1,
a number of configured SSB is more than 1, or
there is more than one RX beam at the terminal device,
wherein the second time length comprises a first time length and the second time length is longer than the first time length.

9. The method of claim 8, wherein the second time length further comprises:
a time duration from an ending time of an activation of a main radio to an end of a complete SSB burst, and
a processing time of SSB.

10. The method of any of claims 7-9, wherein the first time length comprises at least one of:
a feedback delay of acknowledge of the low power wake up signal, or
an activation time of a main radio of the terminal device.

11. The method of claim 10, wherein the first time length further comprises a processing time of the low power wake up signal.

12. The method of claim 6, further comprising:
determining that the at least one PO or PEI-O to be monitored comprises a PO or a PEI-O with a starting time no later than the second time.

13. The method of claim 7, further comprising:
determining that the at least one PO or PEI-O to be monitored comprises a plurality of POs or PEI-Os during a time period between the second time and a third time, a first time length from the first time to the third time being longer than a second time length from the first time to a fourth time, the second time length being determined based on at least one of the conditions:
the terminal device is required to perform SSB measurement after receiving the low power wake up signal and before monitoring the at least one PO or PEI-O,
an SSB associated with the monitoring of the at least one PO or PEI-O is unknown to the terminal device,
an operation band of the terminal device is not FR1,
a number of configured SSB is more than 1, or
there is more than one RX beam at the terminal device.

14. The method of claim 7, further comprising:
determining that the at least one PO or PEI-O to be monitored comprises a first PO or PEI-O and a second PO or PEI-O, the first PO or PEI-O being a PO or PEI-O after the second time, the second PO or PEI-O being a PO or PEI-O after a fourth time, a second time length from the first time to the fourth time being determined based on at least one of the conditions:
the terminal device is required to perform SSB measurement after receiving the low power wake up signal and before monitoring the at least one PO or PEI-O,
an SSB associated with the monitoring of the at least one PO or PEI-O is unknown to the terminal device,
an operation band of the terminal device is not FR1,
a number of configured SSB is more than 1, or
there is more than one RX beam at the terminal device.

15. A method of communication, comprising:
transmitting, at a network device, a low power wake up signal to a terminal device at a first time;
determining a time length from the first time to a second time at which the terminal device is able to start monitoring a paging occasion (PO) or a paging early indication occasion (PEI-O); and
transmitting paging downlink control information (DCI) in the PO or a PEI in the PEI-O after the second time.

16. The method of claim 15, wherein transmitting the paging DCI comprises:
transmitting the paging DCI in a first PO; and
transmitting the paging DCI in a second PO after the first PO.

17. The method of claim 16, further comprising:
in accordance with a reception of a response of the paging DCI transmitted in the first PO from the terminal device, stopping the transmission in the second PO.

18. A terminal device comprising:
a processor; and
a memory storing computer program codes;
the memory and the computer program codes configured to, with the processor, cause the terminal device to perform the method according to any of claims 1-14.

19. A network device comprising:
a processor; and
a memory storing computer program codes;
the memory and the computer program codes configured to, with the processor, cause the network device to perform the method according to any of claims 15-17.

20. A computer readable medium having instructions stored thereon, the instructions, when executed by a processor of an apparatus, causing the apparatus to perform the method according to any of claims 1-17.
